(19) United States
(12) Patent Application Publication
(10) Pub. No.: US 2024/0415200 A1
(43) Pub. Date: Dec. 19, 2024

(54) AEROSOL GENERATING DEVICE

(71) Applicant: KT&G CORPORATION, Daejeon (KR)

(72) Inventors: Hyung Jin Jung, Seoul (KR); Tae Hun Kim, Yongin-si (KR); Ju Eon Park, Seongnam-si (KR); Youn Ji Shin, Seoul (KR); Hun Il Lim, Seoul (KR)

(73) Assignee: KT&G CORPORATION, Daejeon (KR)

(21) Appl. No.: 18/743,464

(22) Filed: Jun. 14, 2024

(30) Foreign Application Priority Data
Jun. 16, 2023 (KR) 10-2023-0077514
Aug. 9, 2023 (KR) 10-2023-0104355

(51) Int. Cl. A24F 40/57; A24F 40/10; A24F 40/20; A24F 40/30; A24F 40/46; A24F 40/51; A24F 40/60; H05B 1/02

(52) U.S. Cl. CPC A24F 40/57; A24F 40/10; A24F 40/20; A24F 40/30; A24F 40/46; A24F 40/51; A24F 40/60; H05B 1/0227

(57) ABSTRACT

An aerosol generating device includes at least one heater configured to heat an aerosol generating material, a memory storing at least one temperature profile and an operation time of the aerosol generating device, a timer turned on by receiving a second control signal and turned off by receiving a first control signal, and a controller configured to control power supplied to the at least one heater based on the operation time, wherein the operation time is stored as a first time, and the controller is further configured to operate the aerosol generating device by adding a second time, in which the timer operates in a turned-on state, to the first time.

### CROSS-REFERENCE TO RELATED APPLICATIONS

This application is based on and claims priority under 35 U.S.C. § 119 to Korean Patent Application No. 10-2023-0077514, filed on Jun. 16, 2023, and Korean Patent Application No. 10-2023-0104355, filed on Aug. 9, 2023, in the Korean Intellectual Property Office, the disclosures of which are incorporated by reference herein in their entirety.

### BACKGROUND

### 1. Field

The disclosure relates to an aerosol generating device.

### 2. Description of the Related Art

Recently, the demand for alternative methods to overcome the shortcomings of general cigarettes has increased. For example, there is a growing demand for systems in which aerosols are generated by heating cigarettes or aerosol generating materials by using aerosol generating devices, rather than methods of generating aerosols by burning cigarettes. Accordingly, research on heating-type aerosol generating devices is actively conducted.

Methods of controlling operations of aerosol generating devices largely include a control method based on the number of puffs of a user and a control method based on operation times.

According to the control method based on the number of puffs, heating is terminated when the number of accumulated puffs reaches a preset number of puffs, and thus, there is a disadvantage of providing a smoking time less than a smoking time desired by a user.

In addition, according to the control method based on the operation time, heating is terminated when a preset time has elapsed after heating is started, despite that a user's puff behavior does not occur, and thus, there is a disadvantage that a cigarette may have to be discarded upon the termination of heating even though an aerosol generating material in the cigarette is not sufficiently exhausted.

### SUMMARY

Embodiments provide an aerosol generating device that may allow a user's smoking behavior to the greatest extent possible.

Objects to be achieved by the embodiments are not limited to the object described above, and other objects may be inferred from the following embodiments.

Additional aspects will be set forth in part in the description which follows and, in part, will be apparent from the description, or may be learned by practice of the presented embodiments of the disclosure.

According to an embodiment, an aerosol generating device includes at least one heater configured to heat an aerosol generating material, a memory storing at least one temperature profile and an operation time of the aerosol generating device, a timer turned on by receiving a second control signal and turned off by receiving a first control signal, and a controller configured to control power supplied to the at least one heater based on the operation time, wherein the operation time is stored as a first time, and the controller is further configured to operate the aerosol generating device by adding a second time, in which the timer operates in a turned-on state, to the first time.

According to another embodiment, an aerosol generating device at least one heater configured to heat an aerosol generating material, a memory storing at least one temperature profile and an operation time of the aerosol generating device, a timer configured to count an operation time of the aerosol generating device, and a controller configured to control power supplied to the at least one heater, wherein the controller is further configured to generate a second control signal for pausing the timer and a first control signal for restarting the timer, and disconnect the power supplied to the heater when the operation time expires.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an aerosol generating device according to an embodiment;

FIG. 2 is a view illustrating an aerosol generating device according to an embodiment;

FIG. 3 is a block diagram of an aerosol generating device according to an embodiment;

FIG. 4 is a flowchart of a method of controlling an aerosol generating device, according to an embodiment;

FIGS. 5 and 6 are diagrams of temperature profiles of a heater, according to an embodiment;

FIG. 7 is a diagram illustrating an example of a power profile and a temperature profile for a first heater in a plurality of modes, according to an embodiment;

FIG. 8 is a diagram illustrating an example of a power profile and a temperature profile for a second heater in a plurality of modes, according to an embodiment; and

FIGS. 9A to 9B are views for describing operations of an aerosol generating device according to an embodiment.

### DETAILED DESCRIPTION

The terms used in the embodiments are general terms that are currently widely used as much as possible while considering functions in the disclosure, but this may change depending on the intention or precedent of a person working in the art, the emergence of new technology, and so on. Also, in a certain case, there are terms randomly selected by the applicant, and in this case, the meaning is described in detail in the relevant description of the disclosure. Therefore, the terms used in the disclosure should be defined based on the meaning of the term and the overall content of the disclosure, rather than simply the name of the term.

When it is described that a portion “includes” a certain element throughout the specification, this means that, unless specifically stated to the contrary, the portion does not exclude other elements but may further include other elements. Also, a term, such as a “unit”, a “portion”, or a “module”, used in the specification refers to a unit that processes at least one function or operation, which may be implemented by hardware, software, or a combination of hardware and software.

As described herein, when an expression, such as “at least one” precedes arranged elements, the expression modifies all of the arranged elements rather than each of the arranged elements. For example, an expression “at least one of a, b, and c” should be interpreted to include a, b, c, a and b, a and c, b and c, or a, b, and c.

In one embodiment, an aerosol generating device may generate an aerosol by electrically heating a stick accommodated in an internal space of the aerosol generating device.

The aerosol generating device may include a heater. In one embodiment, the heater may be an electrically resistive heater. For example, a heater may include an electroconductive track, and the heater may be heated when a current flows through the electroconductive track.

The heater may include a tube-shaped heating element, a plate-shaped heating element, a needle-shaped heating element, or a rod-shaped heating element and may heat the inside or outside of the stick depending on shapes of heating elements.

The stick may include a tobacco rod and a filter rod. The tobacco rod may be made of a sheet, a strand, or cut fillers obtained by finely cutting a tobacco sheet. Also, the tobacco rod may be surrounded by a heat-conducting material. For example, the heat-conducting material may be a metal foil, such as aluminum foil, but is not limited thereto.

The filter rod may be a cellulose acetate filter. The filter rod may include at least one segment. For example, the filter rod may include a first segment that cools an aerosol and a second segment that filters certain components included in the aerosol.

In another embodiment, an aerosol generating device may generate an aerosol by using a cartridge including an aerosol generating material.

The aerosol generating device may include a cartridge holding an aerosol generating material and a main body supporting the cartridge. The cartridge may be detachably coupled to the main body but is not limited thereto. The cartridge may be formed or assembled integrally with the main body and may also be fixed so as not to be attached or detached by a user. The cartridge may be mounted on the main body while including an aerosol generating material therein. However, the disclosure is not limited thereto, and an aerosol generating material may also be injected into the cartridge while the cartridge is coupled to the main body.

The cartridge may include an aerosol generating material in any one of various states, such as a liquid state, a solid state, a gas state, and a gel state. An aerosol generating material may include a liquid composition. For example, the liquid composition may include a tobacco-containing material, including volatile tobacco flavor components or may include a non-tobacco material.

The cartridge is operated by an electric signal or wireless signal transmitted from the main body, thereby converting a phase of the aerosol generating material in the cartridge into a gas phase to generate an aerosol. An aerosol may refer to a gas in a state in which the vaporized particles generated from an aerosol generating material are mixed with air.

In another embodiment, an aerosol generating device may heat a liquid composition to generate an aerosol, and the generated aerosol may be transferred to a user through a stick. That is, the aerosol generated from the liquid composition may move along an airflow path of the aerosol generating device, and the airflow path may be configured to allow an aerosol to pass through the stick and be transferred to a user.

In another embodiment, an aerosol generating device may generate an aerosol from an aerosol generating material by using an ultrasonic vibration method. In this case, the ultrasonic vibration method may refer to a method of generating an aerosol by atomizing an aerosol generating material with ultrasonic vibration generated by a vibrator.

The aerosol generating device may include a vibrator and generate short-cycle vibration through the vibrator to atomize an aerosol generating material. The vibration generated by the vibrator may be ultrasonic vibration, and a frequency bandwidth of the ultrasonic vibration may be from about 100 kHz to about 3.5 MHz but is not limited thereto.

The aerosol generating device may further include a wick that absorbs an aerosol generating material. For example, the wick may surround at least one region of a vibrator or may be in contact with at least one region of the vibrator.

As a voltage (for example, an alternating current (AC) voltage) is applied to the vibrator, heat and/or ultrasonic vibration may be generated by the vibrator, and the heat and/or ultrasonic vibration generated by the vibrator may be transferred to an aerosol generating material absorbed into the wick. The aerosol generating material absorbed into the wick may be converted into a gas phase by heat and/or ultrasonic vibration transferred from the vibrator, and as a result, an aerosol may be generated.

For example, the viscosity of an aerosol generating material absorbed into the wick may be reduced by the heat generated by the vibrator, and the aerosol generating material with the reduced viscosity due to the ultrasonic vibration generated by the vibrator may be converted into fine particles, and thereby, an aerosol may be generated but is not limited thereto.

In another embodiment, an aerosol generating device may generate an aerosol by heating an aerosol generating article accommodated in the aerosol generating device by using an induction heating method.

The aerosol generating device may include a susceptor and a coil. In one embodiment, the coil may apply a magnetic field to the susceptor. As power is supplied to the coil from the aerosol generating device, a magnetic field may be formed inside the coil. In one embodiment, the susceptor may be a magnetic body that generates heat by an external magnetic field. As the susceptor is inside the coil and a magnetic field is applied to the susceptor to cause the susceptor to generate heat, an aerosol generating article may be heated. Also, the susceptor may be selectively placed inside the aerosol generating article.

In another embodiment, the aerosol generating device may further include a cradle.

The aerosol generating device may constitute a system with a separate cradle. For example, the cradle may charge a battery of the aerosol generating device. Also, a heater may be heated in a state where the cradle is coupled to the aerosol generating device.

Hereinafter, embodiments are described in detail with reference to the attached drawings such that those skilled in the art may easily implement the embodiments. The disclosure may be implemented in a form that may be implemented by aerosol generating devices according to various embodiments described above or may be implemented in a variety of different forms and is not limited to the embodiments described herein.

Hereinafter, embodiments are described in detail with reference to the drawings.

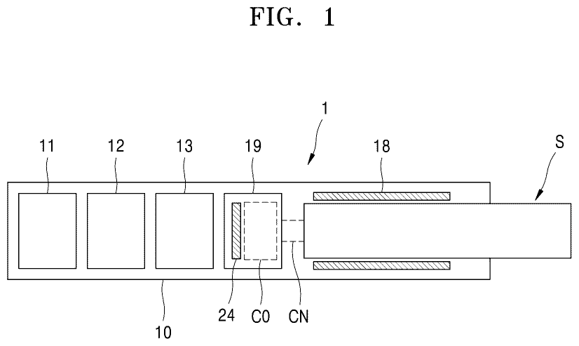

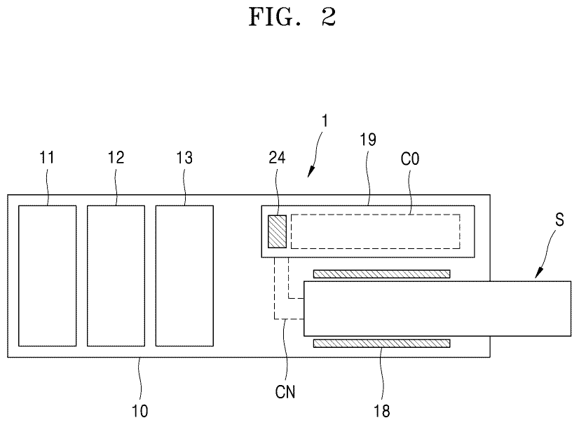

FIGS. 1 and 2 illustrate an aerosol generating device 1 according to embodiments.

Referring to FIG. 1, the aerosol generating device 1 may include at least one of a power source 11, a controller 12, a sensor 13, a heater 18, and a cartridge 19. At least one of the power source 11, the controller 12, the sensor 13, and the heater 18 may be arranged inside a body 10 of the aerosol-generating device 1. The body 10 may provide a space opened upwards so that a stick S, which is an aerosol generating article, is inserted thereinto. The space opened upwards may be referred to as an insertion space. The insertion space may be formed by being recessed toward the inside of the body 10 by a certain depth so that at least a portion of the stick S may be inserted thereinto. The depth of the insertion space may correspond to a length of a region in the stick S, which includes an aerosol generating material and/or a medium. A lower end of the stick S may be inserted into the body 10, and an upper end of the stick S may protrude to the outside of the body 10. A user may inhale air by holding, in the mouth, the upper end of the stick S exposed to the outside.

The heater 18 may heat the stick S. The heater 18 may extend long upwards around a space into which the stick S is inserted. For example, the heater 18 may be in the form of a tube including a hollow therein. The heater 18 may be arranged around the insertion space. The heater 18 may be arranged to surround at least a portion of the insertion space. The heater 18 may heat the insertion space or the stick S inserted into the insertion space. The heater 18 may include an electrically resistive heater and/or an induction heater.

For example, the heater 18 may be a resistive heater. For example, the heater 18 may include an electrically conductive track and the heater 18 may be heated when currents flow through the electrically conductive track. The heater 18 may be electrically connected to the power source 11. The heater 18 may be provided with a current from the power source 11 and directly generate heat.

For example, the aerosol generating device 1 may include an induction coil surrounding the heater 18. The induction coil may generate heat in the heater 18. The heater 18 may be a susceptor, and the heater 18 may generate heat by a magnetic field generated by an AC current flowing through the induction coil. The magnetic field may pass through the heater 18 and generate an eddy current within the heater 18. The current may generate heat in the heater 18.

Meanwhile, a susceptor may be included inside the stick S, and the susceptor inside the stick S may generate heat by the magnetic field generated by the AC current flowing through the induction coil.

The cartridge 19 may contain an aerosol generating material in any one of a liquid state, a solid state, a gaseous state, a gel state, and the like. The aerosol generating material may include a liquid composition. For example, the liquid composition may be a liquid including a tobacco-containing material having a volatile tobacco flavor component, or a liquid including a non-tobacco material.

The cartridge 19 may be integrally formed with the body 10 or detachably coupled to the body 10.

For example, referring to FIG. 1, the cartridge 19 may be integrally formed with the body 10 and may communicate with the insertion space through an air flow channel CN.

For example, referring to FIG. 2, a space may be formed in one side of the body 10, and at least a portion of the cartridge 19 may be inserted into the space formed in one side of the body 10, so that the cartridge 19 may be mounted in the body 10. The air flow channel CN may be defined by a portion of the cartridge 19 and/or a portion of the body 10, and the cartridge 19 may communicate with the insertion space through the air flow channel CN.

The body 10 may be formed in a structure in which external air may be introduced into the body 10 while the cartridge 19 is inserted the body 10. Here, the external air introduced into the body 10 may pass through the cartridge 19 and flow into the mouth of the user.

The cartridge 19 may include a storage CO containing the aerosol generating material and/or a heater 24 heating the aerosol generating material in the storage CO. A liquid delivery element impregnated with (containing) the aerosol generating material may be arranged inside the storage CO. Here, the liquid delivery element may include a wick or the like such as a cotton fiber, a ceramic fiber, a glass fiber, or porous ceramic. An electrically conductive track of the heater 24 may be formed in a coil-shaped structure that is wound around the liquid delivery element or in a structure in contact with one side of the liquid delivery element.

Hereinafter, the heater 18 may be referred to as a first heater 18. The heater 24 may be referred to as a second heater 24 or a cartridge heater 24.

The cartridge 19 may generate an aerosol. When the liquid delivery element is heated by the cartridge heater 24, an aerosol may be generated. The aerosol may be generated by heating the stick S by the heater 18. While the aerosol generated by the cartridge heater 24 and the heater 18 passes through the stick S, a tobacco material may be added to the aerosol, and the aerosol having the tobacco material added thereto may be inhaled into the mouth of the user through one end of the stick S.

The aerosol generating device 1 may include only the cartridge heater 24 and may not include the heater 18 in the body 10. Here, the aerosol generated by the cartridge heater 24 may have the tobacco material added thereto while passing through the stick S and may be inhaled into the mouth of the user.

The aerosol generating device 1 may include a cap (not shown). The cap may be detachably coupled to the body 10 to cover at least a portion of the cartridge 19 coupled to the body 10. The stick S may pass through the cap and be inserted into the body 10.

The power source 11 may supply power so that components of the aerosol generating device 1 operate. The power source 11 may be referred to as a battery. The power source 11 may supply power to at least one of the controller 12, the sensor 13, the cartridge heater 24, and the heater 18. When the aerosol generating device 1 includes an induction coil, the power supply 11 may supply power to the induction coil.

The controller 12 may control an overall operation of the aerosol generating device 1. The controller 12 may be mounted on a printed circuit board (PCB). The controller 12 may control an operation of at least one of the power source 11, the sensor 13, the heater 18, and the cartridge 19. The controller 12 may control operations of a display, a motor, and the like installed in the aerosol generating device 1. The controller 12 may check a state of each of the components of the aerosol generating device 1 to determine whether or not the aerosol generating device 1 is able to operate.

The controller 12 may analyze a result of detection by the sensor 13 and control processes to be performed subsequently. For example, the controller 12 may control power supplied to the cartridge heater 24 and/or the heater 18 so that the operation of the cartridge heater 24 and/or the heater 18 is initiated or terminated, on the basis of the result of the detection by the sensor 13. For example, on the basis of the result of the detection by the sensor 13, the controller 12 may control an amount of power supplied to the cartridge heater 24 and/or the heater 18 and a time for which the power is supplied to the cartridge heater 24 and/or the heater 18 so that the cartridge heater 24 and/or the heater 18 may be heated to a certain temperature or maintain an appropriate temperature.

The sensor 13 may include at least one of a temperature sensor, a puff sensor, an insertion detection sensor, a color sensor, a cartridge detection sensor, and a cap detection sensor. For example, the sensor 13 may sense at least one of a temperature of the heater 18, a temperature of the power source 11, and a temperature inside and outside the body 10. For example, the sensor 13 may sense a puff by a user. For example, the sensor 13 may sense whether or not the stick S is inserted into the insertion space. For example, the sensor 13 may sense whether or not the cartridge 19 is mounted in the body 10. For example, the sensor 13 may sense whether or not the cap is mounted on the body 10.

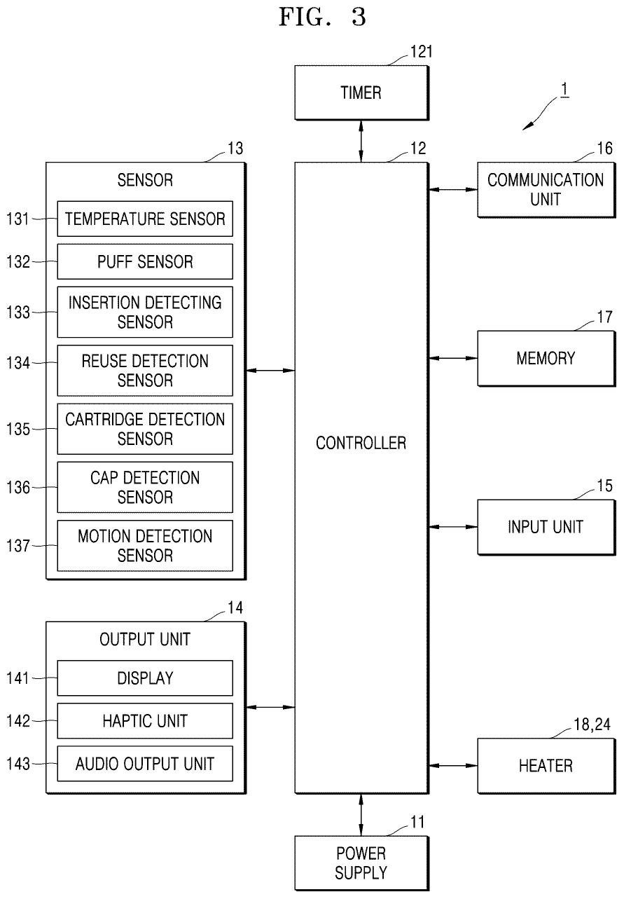

FIG. 3 is a block diagram of an aerosol generating device 1 according to an embodiment.

The aerosol generating device 1 may include a power supply 11, a controller 12, a sensor 13, an output unit 14, an input unit 15, a communication unit 16, a memory 17, at least one heater 18 and 24, and a timer 121. However, an internal structure of the aerosol generating device 1 is not limited to that illustrated in FIG. 3. In other words, according to the design of the aerosol generating device 1, one of ordinary skill in the art related to the present embodiment that some of the components shown in FIG. 3 may be omitted or new components may be added.

The sensor 13 may detect a state of the aerosol generating device 1 or a state around the aerosol generating device 1 and transmit detected information to the controller 12. On the basis of the detected information, the controller 12 may control the aerosol generating device 1 to perform various functions such as control of operations of the cartridge heater 24 and/or the heater 18, a restriction on smoking, determination of whether or not the stick S and/or the cartridge 19 are inserted, and a notification display.

The sensor 13 may include at least one of a temperature sensor 131, a puff sensor 132, an insertion detection sensor 133, a reuse detection sensor 134, a cartridge detection sensor 135, a cap detection sensor 136, and a motion detection sensor 137.

The temperature sensor 131 may detect a temperature at which the cartridge heater 24 and/or the heater 18 are heated. The aerosol generating device 1 may include a separate temperature sensor for detecting the temperatures of the cartridge heater 24 and/or the heater 18, or the cartridge heater 24 and/or the heater 18 may operate as temperature sensors.

The temperature sensor 131 may output a signal corresponding to the temperature of the cartridge heater 24 and/or the heater 18. For example, the temperature sensor 131 may include a resistor element whose resistance value changes in correspondence to a change in the temperature of the cartridge heater 24 and/or the heater 18. The temperature sensor 131 may be implemented by a thermistor or the like, which is an element using a property of changing resistance according to temperature. Here, the temperature sensor 131 may output a signal corresponding to the resistance value of the resistor element as a signal corresponding to the temperature of the cartridge heater 24 and/or the heater 18. For example, the temperature sensor 131 may include a sensor that detects a resistance value of the cartridge heater 24 and/or the heater 18. Here, the temperature sensor 131 may output a signal corresponding to the resistance value of the cartridge heater 24 and/or the heater 18 as a signal corresponding to the temperature of the cartridge heater 24 and/or the heater 18.

The temperature sensor 131 may be arranged around the power source 11 to monitor a temperature of the power source 11. The temperature sensor 131 may be arranged adjacent to the power source 11. For example, the temperature sensor 131 may be attached to one surface of a battery that is the power source 11. For example, the temperature sensor 131 may be mounted on one surface of a PCB.

The temperature sensor 131 may be arranged inside the body 10 to detect an internal temperature of the body 10.

The puff sensor 132 may detect a user's puff based on various physical changes in an airflow path. For example, the puff sensor 132 may detect a user's puff based on any one of a temperature change, a flow change, a voltage change, and a pressure change. The puff sensor 132 may output a signal corresponding to the puff.

In one embodiment, the puff sensor 132 may include a pressure sensor. The pressure sensor may output a sensing signal corresponding to internal pressure of the aerosol generating device 1. Here, the internal pressure of the aerosol generating device 1 may correspond to the pressure of the airflow path (for example, an airflow path CN in FIGS. 1 and 2) through which a gas flows. The pressure sensor may be arranged to correspond to the airflow path through which a gas flows in the aerosol generating device 1.

The pressure sensor may output a first sensing signal and a second sensing signal having opposite polarities depending on directions of an airflow of the airflow path. For example, while a user exhales, the pressure sensor may output the first sensing signal having a first polarity, and while the user inhales, the pressure sensor may output the second sensing signal having a polarity opposite to the first polarity. For example, the first polarity may be a positive polarity, and the second polarity may be a negative polarity. The controller may determine a user's exhalation or inhalation based on the polarity of the sensing signal from the pressure sensor.

In one embodiment, the puff sensor 132 may include a flow sensor. The flow sensor may measure an airflow in the airflow path. The flow sensor may output the first sensing signal and the second sensing signal having opposite polarities depending on directions of the airflow in the airflow path. For example, while a user exhales, the flow sensor may output the first sensing signal having the first polarity, and while the user inhales, the flow sensor may output the second sensing signal having a polarity opposite to the first polarity. For example, the first polarity may be a positive polarity, and the second polarity may be a negative polarity. The controller may determine a user's exhalation or inhalation based on the polarity of a sensing signal from the flow sensor.

The insertion detection sensor 133 may detect insertion and/or removal of the stick S. The insertion detection sensor 133 may detect a signal change due to the insertion and/or removal of the stick S. The insertion detection sensor 133 may be installed around an insertion space. The insertion detection sensor 133 may detect the insertion and/or removal of the stick S according to a change in a dielectric constant inside the insertion space. For example, the insertion detection sensor 133 may be an inductive sensor and/or a capacitance sensor.

The inductive sensor may include at least one coil. The coil of the inductive sensor may be arranged adjacent to the insertion space. For example, when a magnetic field changes around the coil through which a current flows, characteristics of the current flowing through the coil may change according to Faraday's law of electromagnetic induction. Here, the characteristics of the current flowing through the coil may include a frequency of an alternating current, a current value, a voltage value, an inductance value, an impedance value, and the like.

The inductive sensor may output a signal corresponding to the characteristics of the current flowing through the coil. For example, the inductive sensor may output a signal corresponding to an inductance value of the coil.

The capacitance sensor may include a conductor. The conductor of the capacitance sensor may be arranged adjacent to the insertion space. The capacitance sensor may output a signal corresponding to an ambient electromagnetic characteristic, e.g., a capacitance around the conductor. For example, when the stick S including a metal wrapper is inserted into the insertion space, the electromagnetic characteristic around the conductor may be changed by the wrapper of the stick S.

The reuse detection sensor 134 may detect whether or not the stick S is reused. The reuse detection sensor 134 may be a color sensor. The color sensor may detect a color of the stick S. The color sensor may detect a color of a portion of the wrapper wrapping the outside of the stick S. The color sensor may detect a value for an optical characteristic corresponding to a color of an object, on the basis of light reflected from the object. For example, the optical characteristic may be a wavelength of light. The color sensor may be implemented as a single component with a proximity sensor or may be implemented as a separate component distinguished from the proximity sensor.

At least a portion of the wrapper constituting the stick S may have a color changing by an aerosol. When the stick S is inserted into the insertion space, the reuse detection sensor 134 may be arranged in correspondence to a location at which at least the portion of the wrapper whose color changes by the aerosol is arranged. For example, before the stick S is used by the user, the color of at least the portion of the wrapper may be a first color. Here, when at least the portion of the wrapper is wetted by the aerosol while the aerosol generated by the aerosol generating device 1 passes through the stick S, the color of at least the portion of the wrapper may be changed to a second color. The color of at least the portion of the wrapper may be maintained in the second color after changing from the first color to the second color.

The cartridge detection sensor 135 may detect mounting and/or removal of the cartridge 19. The cartridge detection sensor 135 may be implemented by an inductance-based sensor, a capacitive sensor, a resistance sensor, a hall sensor (a hall IC) using a hall effect, or the like.

The cap detection sensor 136 may detect mounting and/or removal of a cap. When the cap is detached from the body 10, a portion of the cartridge 19 and the body 10 covered by the cap may be exposed to the outside. The cap detection sensor 136 may be implemented by a contact sensor, a hall sensor (a hall IC), an optical sensor, or the like.

The motion detection sensor 137 may detect a motion of the aerosol generating device 1. The motion detection sensor 137 may be implemented as at least one of an acceleration sensor and a gyro sensor.

In addition to the sensors 131 to 137 described above, the sensor 13 may further include at least one of a humidity sensor, an atmospheric pressure sensor, a magnetic sensor, a position sensor (e.g., a global positioning system (GPS)), and a proximity sensor. Functions of the respective sensors may be intuitively inferred from names thereof by one of ordinary skill in the art, and thus, detailed descriptions thereof may be omitted.

The output unit 14 may output information regarding the state of the aerosol generating device 1 and provide the information to the user. The output unit 14 may include at least one of a display 141, a haptic unit 142, and a sound output unit 143, but is not limited thereto. When the display 141 and a touch pad form a layer structure to form a touch screen, the display 141 may be used as an input device in addition to an output device.

The display 141 may visually provide the user with information regarding the aerosol generating device 1. For example, the information regarding the aerosol generating device 1 may refer to various types of information such as a charging/discharging state of the power source 11 of the aerosol-generating device 1, a preheating state of the heater 18, the insertion/removal state of the stick S and/or the cartridge 19, the mounting/removal state of the cap, and the restriction on use of the aerosol generating device 1 (e.g., detection of an abnormal article), and the display 141 may output the information to the outside. For example, the display 141 may be in the form of a light emitting diode (LED) light emitting device. For example, the display 141 may be a liquid crystal display (LCD) panel, an organic light emitting display (OLED) panel, or the like.

The haptic unit 142 may tactilely provide the user with the information regarding the aerosol generating device 1 by converting an electrical signal into a mechanical stimulus or an electrical stimulus. For example, when initial power is supplied to the cartridge heater 24 and/or the heater 18 for a set time, the haptic unit 142 may generate vibration corresponding to completion of initial preheating. The haptic unit 142 may include a vibration motor, a piezoelectric element, or an electrical stimulation device.

The sound output unit 143 may audibly provide the user with the information regarding the aerosol generating device 1. For example, the sound output unit 143 may convert the electrical signal into a sound signal and output the sound signal to the outside.

The power supply 11 may supply power used to operate the aerosol generating device 1. The power source 11 may supply power so that the cartridge heater 24 and/or the heater 18 may be heated. In addition, the power source 11 may supply power needed for operations of the sensor 13, the output unit 14, the input unit 15, the communicator 16, and the memory 17, which are other components provided within the aerosol generating device 1. The power source 11 may be a rechargeable battery or a disposable battery. For example, the power supply 11 may be a lithium polymer (LiPoly) battery, but is not limited thereto.

Although not shown in FIG. 3, the aerosol generating device 1 may further include a power protection circuit. The power protection circuit may be electrically connected to the power source 11 and may include a switching element.

The power protection circuit may cut off an electrical path for the power source 11 according to a certain condition. For example, the power protection circuit may cut off the electrical path for the power source 11 when a voltage level of the power source 11 is a first voltage or more corresponding to overcharging. For example, the power protection circuit may cut off the electrical path for the power source 11 when the voltage level of the power source 11 is less than a second voltage corresponding to overdischarge.

The heater 18 may be supplied with power from the power source 11 and heat a medium or an aerosol generating material within the stick S. Although not shown in FIG. 3, the aerosol generating device 1 may further include a power conversion circuit (e.g., a DC/DC converter) that converts power of the power source 11 and supplies the converted power to the cartridge heater 24 and/or the heater 18. In addition, when the aerosol generating device 1 generates an aerosol by an induction heating method, the aerosol generating device 1 may further include a DC/AC converter that converts DC power of the power source 11 into AC power.

The controller 12, the sensor 13, the output unit 14, the input unit 15, the communicator 16, and the memory 17 may be supplied with power from the power source 11 to perform functions. Although not shown in FIG. 3, the aerosol generating device 1 may further include a power conversion circuit that converts power of the power source 11 and supplies the power to each of components, e.g., a low-dropout (LDO) circuit or a voltage regulator circuit. Also, although not shown in FIG. 3, a noise filter may be provided between the power source 11 and the heater 18. The noise filter may be a low pass filter. The low pass filter may include at least one inductor and a capacitor. A cutoff frequency of the low pass filter may correspond to a frequency of a high-frequency switching current applied from the power source 11 to the heater 18. The low pass filter may prevent a high-frequency noise component from being applied to the sensor 13, such as the insertion detection sensor 133.

In an embodiment, the cartridge heater 24 and/or the heater 18 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, or nichrome, but is not limited thereto. In addition, the heater 18 may be implemented by a metal wire, a metal plate on which an electrically conductive track is arranged, or a ceramic heating element, but is not limited thereto.

In an embodiment, the heater 18 may include an induction heater. For example, the heater 18 may include a susceptor that generates heat through a magnetic field applied by a coil to heat an aerosol generating material.

The input unit 15 may receive information input from the user or output the information to the user. For example, the input unit 15 may be a touch panel. The touch panel may include at least one touch sensor for detecting a touch. For example, the touch sensor may include a capacitive touch sensor, a resistive touch sensor, a surface acoustic touch sensor, an infrared touch sensor, or the like, but is not limited thereto.

The display 141 and the touch panel may be implemented as one panel. For example, the touch panel may be inserted into the display 141 (e.g., may be a on-cell type or in-cell type). For example, the touch panel may be added on the display 141 (e.g., may be an add-on type).

Meanwhile, the input unit 15 may include a button, a keypad, a dome switch, a jog wheel, a jog switch, or the like, but is not limited thereto.

The memory 17 may be hardware for storing various types of data processed within the aerosol generating device 1 and may store pieces of data processed by the controller 12 and pieces of data to be processed by the controller 12. The memory 17 may include at least one type of storage medium from among a flash memory type, a hard disk type, a multimedia card micro type, a card type memory (e.g., a SD or XD memory or the like), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 17 may store data or the like regarding an operation time of the aerosol generating device 1, the maximum number of puffs, the current number of puffs, at least one temperature profile, and a smoking pattern of the user.

The communicator 16 may include at least one component for communication with another electronic device. For example, the communicator 16 may include at least one of a short-range wireless communication unit and a wireless communication unit.

The short-range wireless communication unit may include a Bluetooth communication unit, a Bluetooth low energy (BLE) communication unit, a near field communication unit, a wireless local area network ((WLAN) (Wi-Fi)) communication unit, a Zigbee communication unit, an infrared data association (IrDA) communication unit, a Wi-Fi Direct (WFD) communication unit, an ultra wideband (UWB) communication unit, an Ant+ communication unit, and the like, but is not limited thereto.

The wireless communication unit may include a cellular network communication unit, an Internet communication unit, a computer network (e.g., LAN or WAN) communication unit, and the like, but is not limited thereto.

In one embodiment, the timer 121 may be turned on by receiving a second control signal and turned off by receiving a first control signal. The first control signal and the second control signal may be received from the controller 12.

In another embodiment, the timer 121 may count an operation time of the aerosol generating device. The timer 121 may pause by receiving the second control signal and may start counting again by receiving the first control signal.

Although FIG. 3 illustrates that the timer 121 is configured separately from the controller 12, this is for the sake of convenience of description, and the timer 121 may be built in the controller 12 to form a single IC chip.

Although not shown in FIG. 3, the aerosol generating device 1 may further include a connection interface such as a universal serial bus (USB) interface, and may connect with another external device through the connection interface such as a USB interface to transmit and receive information or charge the power 11.

The controller 12 may control an overall operation of the aerosol generating device 1. In an embodiment, the controller 12 may include at least one processor. The processor may be implemented as an array of a plurality of logic gates or may be implemented as a combination of a general-purpose microprocessor and a memory that stores a program executable by the microprocessor. In addition, one of ordinary skill in the art to which the present embodiment pertains may understand that the processor may be implemented as other types of hardware.

The controller 12 may control the temperature of the heater 18 by controlling supply power from the power source 11 to the heater 18. The controller 12 may control the temperature of the cartridge heater 24 and/or the heater 18 on the basis of the temperature of the cartridge heater 24 and/or the heater 18 sensed by the temperature sensor 131. The controller 12 may adjust power supplied to the cartridge heater 24 and/or the heater 18, on the basis of the temperature of the cartridge heater 24 and/or the heater 18. For example, the controller 12 may determine a target temperature for the cartridge heater 24 and/or the heater 18, on the basis of a temperature profile stored in the memory 17.

The aerosol generating device 1 may include a power supply circuit (not shown) electrically connected to the power source 11 between the power source 11 and the cartridge heater 24 and/or the heater 18. The power supply circuit may be electrically connected to the cartridge heater 24, the heater 18, or an induction coil. The power supply circuit may include at least one switching element. The switching element may be implemented by a bipolar junction transistor (BJT), a field effective transistor (FET), or the like. The controller 12 may control the power supply circuit.

The controller 12 may control power supply by controlling switching of the switching element of the power supply circuit. The power supply circuit may be an inverter that converts DC power output from the power source 11 into AC power. For example, the inverter may include a full-bridge circuit or a half-bridge circuit including a plurality of switching elements.

The controller 12 may turn on the switching element so that power is supplied from the power source 11 to the cartridge heater 24 and/or the heater 18. The controller 12 may turn off the switching element to cut off the supply of power to the cartridge heater 24 and/or the heater 18. The controller 12 may adjust a current supplied from the power source 11 by adjusting a frequency and/or duty ratio of a current pulse input into the switching element.

The controller 12 may control a voltage output from the power source 11 by controlling switching of the switching element of the power supply circuit. The power conversion circuit may convert the voltage output from the power source 11. For example, the power conversion circuit may include a buck-converter that steps down the voltage output from the power source 11. For example, the power conversion circuit may be implemented through a buck-boost converter, a zener diode, or the like.

The controller 12 may adjust a level of the voltage output from the power conversion circuit by controlling an on/off operation of the switching element included in the power conversion circuit. When the switching element continues to be turned on, the level of the voltage output from the power conversion circuit may correspond to a level of a voltage output from the power source 11. The duty ratio for the on/off operation of the switching element may correspond to a ratio of the voltage output from the power conversion circuit to the voltage output from the power source 11. The level of the voltage output from the power conversion circuit may decrease with a decrease in the duty ratio for the on/off operation of the switching element. The heater 18 may be heated on the basis of the voltage output from the power conversion circuit.

The controller 12 may control power to be supplied to the heater 18 by using at least one of a pulse width modulation (PWM) method and a proportional-integral-differential (PID) method.

For example, the controller 12 may control a current pulse having a certain frequency and duty ratio to be supplied to the heater 18 by using the PWM method. The controller 12 may control the power supplied to the heater 18 by adjusting the frequency and duty ratio of the current pulse.

For example, the controller 12 may determine a target temperature to be controlled, on the basis of the temperature profile. The controller 12 may control the power supplied to the heater 18 by using the PID method, which is a feedback control method through a difference value between the temperature of the heater 18 and the target temperature, a value obtained by integrating the difference value over time, and a value obtained by differentiating the difference value over time.

The controller 12 may prevent the cartridge heater 24 and/or the heater 18 from overheating. For example, on the basis that the temperature of the cartridge heater 24 and/or the heater 18 exceeds a preset limit temperature, the controller 12 may control an operation of the power conversion circuit so that the supply of power to the cartridge heater 24 and/or the heater 18 stops. For example, on the basis that the temperature of the cartridge heater 24 and/or the heater 18 exceeds the preset limit temperature, the controller 12 may reduce an amount of power supplied to the cartridge heater 24 and/or the heater 18 by a certain ratio. For example, on the basis that the temperature of the cartridge heater 24 exceeds the preset limit temperature, the controller 12 may determine that the aerosol generating material accommodated in the cartridge 19 is exhausted and cut off the power supply to the cartridge heater 24.

The controller 12 may control charging and discharging of the power source 11. The controller 12 may identify the temperature of the power source 11 on the basis of an output signal of the temperature sensor 131.

When a power line is connected to a battery terminal of the aerosol generating device 1, the controller 12 may identify whether or not the temperature of the power source 11 is a first limit temperature or more which is a reference for blocking charging of the power source 11. When the temperature of the power source 11 is less than the first limit temperature, the controller 12 may control the power source 11 to be charged, on the basis of a preset charging current. The controller 12 may block charging of the power source 11 when the temperature of the power source 11 is the first limit temperature or more.

While the power of the aerosol generating device 1 is turned on, the controller 12 may identify whether or not the temperature of the power source 11 is a second limit temperature or more which is a reference for blocking discharge of the power source 11. The controller 12 may control power stored in the power source 11 to be used when the temperature of the power source 11 is less than the second limit temperature. When the temperature of the power source 11 is the second limit temperature or more, the controller 12 may stop using the power stored in the power source 11.

The controller 12 may calculate a remaining capacity of the power stored in the power source 11. For example, the controller 12 may calculate the remaining capacity of the power source 11 on the basis of a voltage and/or current sensing value of the power source 11.

The controller 12 may determine, through the insertion detection sensor 133, whether or not the stick S is inserted into the insertion space. The controller 12 may determine that the stick S is inserted, on the basis of the output signal of the insertion detection sensor 133. When determining that the stick S is inserted into the insertion space, the controller 12 may control power to be supplied to the cartridge heater 24 and/or the heater 18. For example, the controller 12 may supply power to the cartridge heater 24 and/or the heater 18, on the basis of the temperature profile stored in the memory 17.

The controller 12 may determine whether or not the stick S is removed from the insertion space. For example, the controller 12 may determine, through the insertion detection sensor 133, whether or not the stick S is removed from the insertion space. For example, when the temperature of the heater 18 is the preset limit temperature or more or when a temperature change gradient of the heater 18 is a set gradient, the controller 12 may determine that the stick S is removed from the insertion space. When determining that the stick S is removed from the insertion space, the controller 12 may cut off the supply of power to the cartridge heater 24 and/or the heater 18.

The controller 12 may control a power supply time and/or a power supply amount with respect to the heater 18, according to a state of the stick S detected by the sensor 13. The controller 12 may identify, on the basis of a look-up table, a level range including a level of a signal of the capacitance sensor. The controller 12 may determine an amount of moisture in the stick S, according to the identified level range.

When the stick S is over-humidified, the controller 12 may increase a preheating time of the stick S compared to a normal state by controlling the power supply time with respect to the heater 18.

The controller 12 may determine, through the reuse detection sensor 134, whether or not the stick S inserted into the insertion space is reused. For example, the controller 12 may compare a sensing value of a signal of the reuse detection sensor 134 with a first reference range including a first color and when the sensing value is included in the first reference range, determine that the stick S is not used. For example, the controller 12 may compare the sensing value of the signal of the reuse detection sensor 134 with a second reference range including a second color and when the sensing value is included in the second reference range, determine that the stick S is used. When determining that the stick S is used, the controller 12 may cut off the supply of power to the cartridge heater 24 and/or the heater 18.

The controller 12 may determine, through the cartridge detection sensor 135, whether or not the cartridge 19 is coupled and/or removed. For example, the controller 12 may determine whether or not the cartridge 19 is coupled or removed, on the basis of a sensing value of the signal of the cartridge detection sensor 135.

The controller 12 may determine whether or not the aerosol generating material of the cartridge 19 is exhausted. For example, the controller 12 may apply power to preheat the cartridge heater 24 and/or the heater 18, determine whether or not the temperature of the cartridge heater 24 exceeds the limit temperature in a preheating period, and when the temperature of the cartridge heater 24 exceeds the limit temperature, determine that the aerosol generating material of the cartridge 19 is exhausted. When determining that the aerosol generating material of the cartridge 19 is exhausted, the controller 12 may cut off the supply of power to the cartridge heater 24 and/or the heater 18.

The controller 12 may determine whether or not the cartridge 19 may be used. When the current number of puffs is greater than or equal to the maximum number of puffs set in the cartridge 19, the controller 12 may determine, on the basis of data stored in the memory 17, that the cartridge 19 may not be used. For example, when the total time for which the heater 24 is heated is a preset maximum time or more or the total amount of power supplied to the heater 24 is a preset maximum amount of power or more, the controller 12 may determine that the cartridge 19 may not be used.

The controller 12 may determine inhalation by the user through the puff sensor 132. For example, the controller 12 may determine whether or not a puff occurs, on the basis of a sensing value of a signal of the puff sensor 132. For example, the controller 12 may determine an intensity of the puff, on the basis of the sensing value of the signal of the puff sensor 132. When the number of puffs reaches the preset maximum number of puffs or when puffs are not detected for a preset time or more, the controller 12 may cut off the supply of power to the cartridge heater 24 and/or the heater 18.

The controller 12 may determine, through the cap detection sensor 136, whether a cap is coupled and/or removed. For example, the controller 12 may determine whether or not the cap is coupled and/or removed, on the basis of a sensing value of a signal of the cap detection sensor 136.

The controller 12 may control the output unit 14 on the basis of the result of detection by the sensor 13. For example, when the number of puffs counted through the puff sensor 132 reaches a preset number, the controller 12 may notify the user that the aerosol generating device 1 is soon terminated, through at least one of the display 141, the haptic unit 142, and the sound output unit 143. For example, the controller 12 may notify the user through the output unit 14 that the aerosol generating device 1 is soon terminated, on the basis of the determination that the stick S is not present in the insertion space. For example, the controller 12 may notify the user through the output unit 14 that the aerosol generating device 1 is soon terminated, on the basis of the determination that the cartridge 19 and/or the cap are not mounted. For example, the controller 12 may transmit information regarding the temperature of the cartridge heater 24 and/or the heater 18 to the user through the output unit 14.

The controller 12 may store and update, in the memory 17, a history of a certain event that occurs, on the basis of the occurrence of the event. The event may include detection of insertion of the stick S, initiation of heating of the stick S, detection of puffs, termination of the puffs, detection of overheating of the cartridge heater 24 and/or the heater 18, detection of application of an overvoltage to the cartridge heater 24 and/or the heater 18, termination of heating of the stick S, an operation such as power on/off of the aerosol generating device 1, initiation of charging of the power source 11, detection of overcharging of the power source 11, termination of charging of the power source 11, and the like. The history of the event may include a date and time when the event occurs, log data corresponding to the event, and the like. For example, when the certain event is the detection of insertion of the stick S, the log data corresponding to the event may include data regarding the sensing value of the insertion detection sensor 133 and the like. For example, when the certain event is the detection of overheating of the cartridge heater 24 and/or the heater 18, the log data corresponding to the event may include data regarding the temperature of the cartridge heater 24 and/or the heater 18, the voltage applied to the cartridge heater 24 and/or the heater 18, a current flowing through the cartridge heater 24 and/or the heater 18, and the like.

The controller 12 may control to form a communication link with an external device such as a mobile terminal of the user. When data regarding authentication is received from the external device through the communication link, the controller 12 may release a restriction on use of at least one function of the aerosol generating device 1. Here, the data regarding the authentication may include data indicating completion of user authentication for the user corresponding to the external device. The user may perform the user authentication through the external device. The external device may determine whether or not user data is valid, on the basis of the birthday of the user, a unique number indicating the user, and the like and receive, from an external server, data regarding use authority over the aerosol generating device 1. The external device may transmit the data indicating the completion of the user authentication to the aerosol generating device 1, on the basis of the data regarding the use authority. When the user authentication is completed, the controller 12 may release the restriction on the use of at least one function of the aerosol generating device 1. For example, when the user authentication is completed, the controller 12 may release a restriction on use of a heating function of supplying power to the heater 18.

The controller 12 may transmit data regarding the state of the aerosol generating device 1 to the external device through the communication link formed with the external device. On the basis of the received data regarding the state of the aerosol generating device 1, the external device may output the remaining capacity of the power source 11 of the aerosol generating device 1, an operation mode, and the like through a display of the external device.

The external device may transmit a location search request to the aerosol generating device 1, on the basis of an input for initiating a location search of the aerosol generating device 1. When receiving the location search request from the external device, the controller 12 may control at least one of output devices to perform an operation corresponding to the location search, on the basis of the received location search request. For example, the haptic unit 142 may generate vibration in response to the location search request. For example, the display 141 may output an object corresponding to the location search and an end of the search in response to the location search request.

When receiving firmware data from the external device, the controller 12 may control to perform a firmware update. The external device may identify a current version of firmware of the aerosol generating device 1 and determine whether or not a new version of the firmware is present. When an input for requesting firmware download is received, the external device may receive a new version of firmware data and transmit the new version of firmware data to the aerosol generating device 1. When receiving the new version of firmware data, the controller 12 may control the firmware update of the aerosol generating device 1 to be performed.

The controller 12 may transmit data regarding a sensing value of at least one sensor 13 to the external server (not shown) through the communicator 16, and receive from the server and store a learning model generated by learning the sensing value through machine learning such as deep learning. The controller 12 may perform an operation of determining an inhalation pattern of the user, an operation of generating a temperature profile, and the like by using the learning model received from the server. The controller 12 may store, in the memory 17, sensing value data of at least one sensor 13, data for training an artificial neural network (ANN), and the like. For example, the memory 17 may store a database for each component provided in the aerosol generating device 1, which is for training the ANN, and weights and biases constituting the structure of the ANN. The controller 12 may generate at least one learning model used for determining the inhalation pattern of the user, generating the temperature profile, and the like, by learning data regarding the sensing value of the at least one sensor 13, the inhalation pattern of the user, the temperature profile, and the like which are stored in the memory 17.

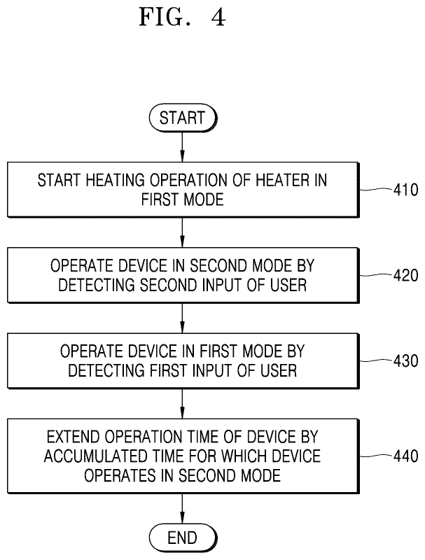

FIG. 4 is a flowchart of a method of controlling an aerosol generating device, according to an embodiment.

Referring to FIGS. 3 and 4, the controller 12 may load an operation time of the aerosol generating device 1 stored in the memory 17 and control the power supplied to the heater 18 or 24 based on the operation time. Specifically, the controller 12 may heat the heater 18 or 24 to generate an appropriate amount of aerosols according to a user's puff during a first time. Here, the first time refers to a preset time to appropriately use a smoking article (for example, a stick or a cartridge) including an aerosol generating material. The first time may be stored in the memory 17. The controller 12 starts a heating operation of the heater 18 or 24 in a first mode in operation 410. The first mode is a mode in which a situation where a user is smoking by using the aerosol generating device 1 is assumed and a control operation is set to suit the situation where the user is smoking.

In the first embodiment, when the controller 12 starts the heating operation of the heater 18 or 24 in the first mode in operation 410, the timer 121 is turned on and may count the operation time of the aerosol generating device 1.

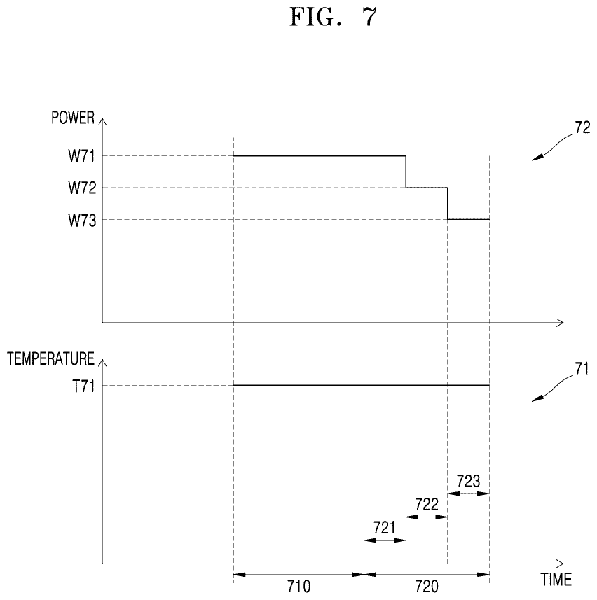

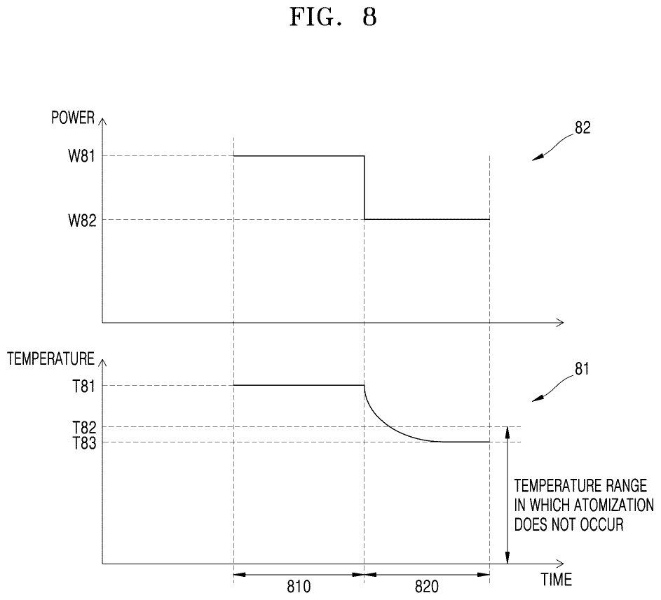

In operation 420, the controller 12 generates a second control signal in response to a second input of a user and operates the aerosol generating device 1 in a second mode. The second mode is a mode in which a situation where a user temporarily stops smoking is assumed and a control operation is set to suit the situation where the user temporarily stops smoking. Here, the second input of the user is the user's input for temporarily stopping smoking and may be received through the user's exhalation, the user's voice input, a button input, or a touch input. The user's exhalation may be detected by a pressure sensor or a flow sensor included in the puff sensor 132. A user's button input or touch input may be received through the input unit 15. In one embodiment, the controller 12 may perform control such that lower power is supplied to the heater in the second mode than in the first mode. A detailed description of the power supplied to the heater in the first mode and the second mode is described below with reference to FIGS. 7 and 8.

In the first embodiment, in operation 420, the controller 12 may generate a second control signal in response to the second input of a user, and the timer 121 may receive the second control signal and pause to count the operation time of the aerosol generating device 1.

In the second embodiment, the timer 121 may be turned on by receiving the second control signal. The timer 121 may count the time when the aerosol generating device 1 operates in the second mode by being turned on by receiving the second control signal.

In operation 430, the controller 12 generates a first control signal by detecting a first input of a user and operates the aerosol generating device 1 again in the first mode.

In the first embodiment, the timer 121 may operate again by receiving the first control signal in operation 430. That is, the timer 121 may cancel a pause state by receiving the first control signal and count the operation time of the aerosol generating device 1 again.

In the first embodiment, when an operation time (TC) of the aerosol generating device 1 which is counted by the timer 121 exceeds the first time that is the operation time of the aerosol generating device 1 which is stored in the memory 17, the controller 12 stops a heating operation of the aerosol generating device 1 by disconnecting the power supplied to the heater. In the first embodiment, because the timer 121 pauses to count the operation time of the aerosol generating device 1 while the aerosol generating device 1 operates in the second mode, and as a result, the operation time of the aerosol generating device 1 is extended by the time for which the aerosol generating device 1 operates in the second mode.

In the second embodiment, the timer 121 may be turned off by receiving the first control signal. As the timer 121 is turned off by receiving the first control signal, the time for which the aerosol generating device 1 operates in the second mode may be selectively counted.

In operation 440, the controller 12 may extend the operation time of the aerosol generating device 1 by the accumulated time for which the aerosol generating device 1 operates in the second mode. In the second embodiment, the timer 121 is turned on by receiving the second control signal and turned off by receiving the first control signal, and accordingly, the timer 121 may accumulate and count the time for which the aerosol generating device 1 operates in the second mode. The controller 12 may extend the operation time of the aerosol generating device 1 by the second time for which the timer 121 operates in a turned-on state.

In one embodiment, when the second time exceeds 120 seconds, the controller 12 may extend the operation time of the aerosol generating device 1 by only 120 seconds, not the second time. When the operation time of the aerosol generating device 1 is extended beyond 120 seconds, overheating or carbonization of the heater 18 or 24 may occur.

As described above, the aerosol generating device 1 according to an embodiment may be switched to the second mode through a second input (an input through an input unit/exhalation) of a user in a situation where the user may pause smoking (for example, telephone conversation and briefly greeting/meeting a non-smoker while smoking).

The aerosol generating device 1 according to the first embodiment counts an operation time of the aerosol generating device 1 excluding the time operated in the second mode, and thus, a sufficient smoking time is provided to increase a user's smoking satisfaction.

Likewise, the aerosol generating device 1 according to the second embodiment counts the time operated in the second mode and extends the operation time of the aerosol generating device 1 by the accumulated time operated in the second mode during a preset operation time of the aerosol generating device 1, and thus, a sufficient smoking time is provided to increase a user's smoking satisfaction.

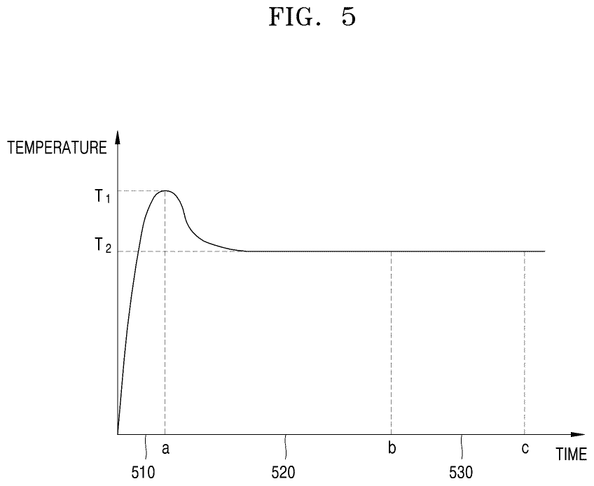

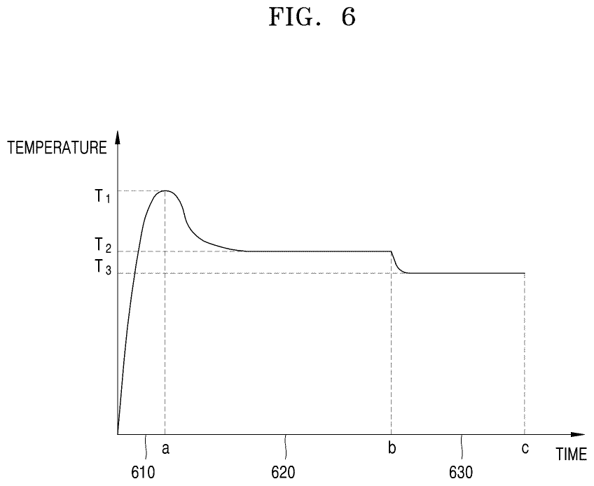

Hereinafter, a method of controlling power supplied to a heater in an extended operation period is described with reference to FIGS. 5 and 6.

FIGS. 5 and 6 are diagrams of temperature profiles of a heater, according to an embodiment.

Referring to FIGS. 1 to 6, when a signal requesting activation of the heater 18 or 24 is generated, the controller 12 supplies power to the heater 18 or 24 such that the heater 18 or 24 starts a heating operation. For example, the signal requesting activation of the heater 18 or 24 may be an input signal input by a user, a signal indicating insertion (fastening) of a stick or cartridge, or so on but is not limited thereto. In one embodiment, a heating operation of the heater 18 or 24 includes preset operations respectively corresponding to a plurality of periods divided according to time.

For example, the heating operation of the heater 18 or 24 may include a first heating operation, a second heating operation, and a third heating operation. The first heating operation may reach a target temperature in a relatively short period of time from when power supply to the heater 18 or 24 is started to prepare for a user to initiate the puff. The second heating operation may be maintained at at least one preset temperature for a first preset time such that an appropriate amount of aerosols may be generated according to a user's puff. The third heating operation may be maintained at at least one preset temperature such that an aerosol may be generated for a second time after the first time elapses.

The first preset time refers to a previously determined time for proper use of a smoking article (for example, a stick or cartridge) including an aerosol generating material. The first time may be stored in the memory 17.

The second time means the total time for which the aerosol generating device 1 operates in the second mode. The timer 121 according to an embodiment may count the total time for which the aerosol generating device 1 operates in the second mode.

When a heating operation of the heater 18 or 24 is started, the controller 12 controls the heating operation of the heater 18 or 24 according to a temperature profile which is previously stored. The temperature profile may refer to a change in temperature of the heater 18 or 24 over time.

Referring to FIGS. 1 to 5, in a first period 510, the controller 12 may control the heater 18 or 24 such that the temperature of the heater 18 or 24 increases from the ambient temperature to a first temperature T1. The first temperature T1 at a first point in time a is a temperature suitable for vaporizing an aerosol generating material and may change depending on smoking environments (for example, temperature, pressure, humidity, a user's smoking pattern, air composition, and so on) in a preset allowable temperature range. A heating operation of the heater 18 or 24 in the first period 510 may correspond to the first heating operation described above.

In a second period 520, the controller 12 may control the heater 18 or 24 such that the temperature of the heater 18 or 24 decreases from the first temperature T1 to a second temperature T2. The second temperature T2 also falls within the allowable temperature range and may be lower than the first temperature T1. The second temperature T2 may be maintained until a preset second point in time b. The second point in time b has a value obtained by adding the first time to the first point in time a. The heating operation of the heater 18 or 24 in the second period 520 may correspond to the second heating operation described above.

The controller 12 may set a target temperature of the heater 18 or 24 for a third period 530 to be the same as the target temperature at the second point in time b which is a point in time when the first time period ends. In other words, in a third period 530, the controller 12 may control the heater 18 or 24 such that the temperature of the heater 18 or 24 is maintained at the second temperature T2 at the second point in time b. A heating operation of the heater 18 or 24 in the third period 530 may correspond to the third heating operation described above and may continue until a third point in time c. The third point in time c has a value obtained by adding the second time to the second point in time b. A length of the third period 530 is a second time that is the time for which the aerosol generating device 1 operated in the second mode.

As the temperature of the heater 18 or 24 in the third period 530 is maintained at the same temperature as the temperature T2 at the second point in time b, the amount of atomization, the feeling of smoking, and so on in the second period 520 may be maintained.

The controller 12 may end the heating operation of the heater 18 or 24 after the third point in time c.

Target temperatures of the heater 18 or 24 in the third periods 530 and 630 are different from each other in FIGS. 5 and 6.

Referring to FIGS. 1 to 6, in the embodiment of FIG. 6, the controller 12 may set a target temperature of the heater 18 or 24 for the third period 630 to be lower than the target temperature at the second point in time b that is a point in time when the first time ends. Specifically, the controller 12 may control the heater 18 or 24 such that, in the third period 630, the temperature of the heater 18 or 24 is maintained at a third temperature T3 that is lower than the second temperature T2 at the second point in time b. The heating operation of the heater 18 or 24 in the third period 630 may correspond to the third heating operation described above and may continue until the third point in time c. For example, the third point in time c is the time for which the aerosol generating device 1 operates in the second mode.

The controller 12 may control the heater 18 or 24 such that, in the third period 630, the temperature of the heater 18 or 24 is maintained at a temperature that is lower than the second temperature T2 at the second point in time b. The third temperature T3 may be set to be lower as the time for which the aerosol generating device 1 operates in the second mode increases. However, the third temperature T3 may be set in a preset allowable temperature range. Here, the preset allowable temperature range is a temperature suitable for vaporizing an aerosol generating material and may be set to a temperature range in which a certain level of the amount of atomization and the feeling of smoking may be provided and carbonization may be prevented.

As the temperature of the heater 18 or 24 in the third period 630 is maintained at a temperature that is lower than the temperature T2 at the second point in time b, it is possible to prevent the heater 18 or 24 from overheating and being carbonized due to depletion of an aerosol generating material and to prevent the feeling of smoking from being reduced.

The controller 12 may end the heating operation of the heater 18 or 24 after the third point in time c.

According to some embodiments, each of the periods 510, 520, 530, 610, 620, and 630 in FIGS. 5 and 6 may be further divided into a plurality of periods, and the controller 12 may control the heating operation of the heater 18 or 24 such that the temperature of the heater 18 or 24 is maintained at a preset temperature corresponding to each of the plurality of periods. In some embodiments, the preset temperature corresponding to each of the plurality of periods included in each of the periods 510, 520, 530, 610, 620, and 630 may be set to gradually increase or decrease over time, may be set to gradually decrease and then increase, or may be set to repeat a combination thereof.

For example, in the third periods 530 and 630, the controller 12 may maintain the temperature of the heater 18 or 24 at the temperature T2 at the second point in time b for a preset time and may maintain the temperature of the heater 18 or 24 at a temperature (for example, T3) that is lower than the temperature T2 after a preset time. Here, the preset time may be selected by the controller 12 depending on smoking environments (for example, temperature, pressure, humidity, a user's smoking pattern, air composition, and so on) obtained through the sensor 13 or memory 17.

Hereinafter, a power profile and a temperature profile for the first heater 18 and the second heater 24 are described with reference to FIGS. 7 and 8.

FIG. 7 is a diagram illustrating an example of a power profile and temperature profile for a first heater in a plurality of modes, according to an embodiment. FIG. 8 is a diagram illustrating an example of a power profile and temperature profile for a second heater in a plurality of modes, according to an embodiment.

As described above, the first heater 18 heats a stick S inserted into the aerosol generating device 1, and the second heater 24 heats the liquid composition stored in the cartridge 19 that is detached from the aerosol generating device 1. In FIGS. 7 and 8, first graphs 71 and 81 represent a temperature profile of the heaters 18 or 24, and second graphs 72 and 82 represent a power profile supplied to the heater 18 or 24. first periods 710 and 810 are periods in which the aerosol generating device 1 operates in the first mode. Second periods 720 and 820 are periods in which the aerosol generating device 1 operates in the second mode.

First, the power supplied to the first heater 18 and the temperature profile of the first heater 18 are described with reference to FIGS. 1 to 7. The controller 12 preferably sets target temperatures of the first heater 18 to be the same in the first mode 710 and the second mode 720. That is, as illustrated in FIG. 7, the first heater 18 is preferably heated to a first temperature T71 in both the first mode 710 and the second mode 720. When temperatures of the first heater 18 heating the stick S are different from each other between the first mode 710 and the second mode 720, there may be a deviation in taste of smoking of an aerosol generated from the stick S.

To this end, the controller 12 preferably controls a level of power supplied to the first heater 18 in the second mode 720 to gradually decrease over time. For example, as illustrated in the second graph 72 of FIG. 7, a first power W71 is supplied to the first heater 18 in a first period 721 of the second mode 720, a second power W72 is supplied to the first heater 18 in a second period 722 of the second mode 720, and a third power W73 is supplied to the first heater 18 in a third period 723 of the second mode 720.

As described above, in a situation where a user may pause smoking, the aerosol generating device 1 may be switched to the second mode 720 through a second input (an input/exhalation of the input unit) of the user.

In addition, in the first mode 710, the temperature of the first heater 18 may be cooled due to a user's puff. In addition, in the second mode 720, a user's puff is paused, and accordingly, cooling of the first heater 18 due to the user's puff may not be expected. Therefore, when the fixed power is supplied to the first heater 18 in the second mode 720, the temperature of the first heater 18 may continuously increase. Because the continuous increase in temperature of the first heater 18 may overheat the stick S to be carbonized, it is preferable that a level of the power supplied to the first heater 18 is controlled to gradually decrease over time rather than a fixed value in the second mode 720.

Next, the power supplied to the second heater 24 and a temperature profile of the second heater 24 are described with reference to FIGS. 1 to 8. The controller 12 preferably sets the target temperature of the second heater 24 in the second mode 820 to be lower than the target temperature of the second heater 24 in the first mode 810. That is, as illustrated in FIG. 8, the second heater 24 is preferably heated in the second mode 820 to a temperature that is lower than a first temperature T81 which is a target temperature in the first mode 810. A liquid composition stored in the cartridge 19 is atomized at a temperature exceeding a second temperature T82 and is not atomized at a temperature that is lower than or equal to the second temperature T82. When the temperature of the second heater 24 is maintained at the first temperature T81 that is higher than the second temperature T82, unnecessary atomization may occur in the second mode 820 in which smoking is not expected. Therefore, in order to prevent unnecessary atomization from occurring in the second mode 820, the temperature of the second heater 24 is required to maintain at a third temperature T83 that is lower than the second temperature T82.

To this end, the controller 12 preferably perform control such that a level of the power supplied to the second heater 24 in the second mode 820 is lower than a level of the power supplied to the second heater 24 in the first mode 810. For example, as illustrated in the second graph 82 of FIG. 8, it is preferable to supply a first power W81 to the second heater 24 in the first mode 810 and to supply a second power W82 that is lower than the first power W81 to the second heater 24 in the second mode 820.

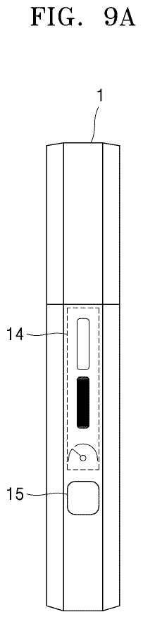

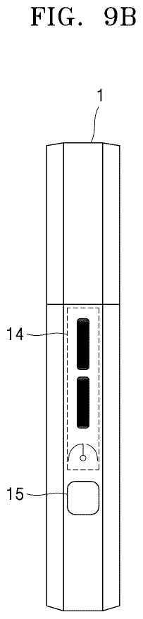

FIGS. 9A to 9B are views for describing operations of an aerosol generating device according to an embodiment.

Referring to FIGS. 9A to 9B, an aerosol generating device 1 may output an operation mode through an output unit. For example, FIG. 9A illustrates a first mode to be output, and FIG. 9B illustrates a second mode to be output.

The aerosol generating device 1 may output a user interface screen, on which an operation mode is displayed, through a display 141. In this case, the user interface screen output through the display 141 may include at least one indicator indicating a plurality of modes. For example, the aerosol generating device 1 may output, through the display 141, a user interface screen including an indicator indicating the mode currently set as an operation mode, based on execution of the function for setting the operation mode.

According to an embodiment, the indicator included in the user interface screen may output the first mode or the second mode to distinguish therebetween.

In one embodiment, the aerosol generating device 1 may set an operation mode based on a user input received through the input unit 15. For example, when the first input of pressing the input unit 15 once for less than a preset time is received, the aerosol generating device 1 may change the indicator included in the user interface screen output through the display 141. For example, when a second input of pressing the input unit 15 for more than a preset time is received, the aerosol generating device 1 may set a mode corresponding to the indicator included in the user interface screen output through the display 141 as the operation mode.

In one embodiment, the aerosol generating device 1 may set an operation mode based on a user's input received through the sensor 13. For example, the aerosol generating device 1 may set an operation mode by distinguishing between exhalation and inhalation of a user through the sensor 13. The aerosol generating device 1 may determine a user's inhalation as the first input and the user's exhalation as the second input.

As described above, an aerosol generating device according to an embodiment controls heating of a heater by considering a pause time in addition to a preset operation time for the aerosol generating device, and thus, a sufficient smoking time is provided to increase a user's smoking satisfaction.

What is claimed is:

1. An aerosol generating device comprising:
at least one heater configured to heat an aerosol generating material;
a memory storing at least one temperature profile and an operation time of the aerosol generating device;
a timer turned on by receiving a second control signal and turned off by receiving a first control signal; and
a controller configured to control power supplied to the at least one heater based on the operation time,
wherein the operation time is stored as a first time, and
the controller is further configured to operate the aerosol generating device by adding a second time, in which the timer operates in a turned-on state, to the first time.

2. The aerosol generating device of claim 1, wherein the controller is further configured to set a target temperature of the at least one heater in a period to which the second time is added to be the same as a target temperature of the at least one heater at an end of the first time.

3. The aerosol generating device of claim 1, wherein the controller is further configured to set a target temperature of the at least one heater in a period to which the second time is added to be lower than a target temperature of the at least one heater at an end of the first time.

4. The aerosol generating device of claim 1, further comprising a puff sensor configured to detect puff of a user,
wherein, when a total number of puffs of the user exceeds a preset number of puffs, the controller is further configured to disconnect the power supplied to the at least one heater.

5. The aerosol generating device of claim 1, further comprising an input unit configured to receive information that is input from the user,
wherein the controller is further configured to generate the first control signal in response to a first input of the user or generates the second control signal in response to a second input of the user.

6. The aerosol generating device of claim 1, further comprising a sensor configured to detect a physical change in an airflow path,
wherein the controller is further configured to generate the first control signal in response to a first sensing signal output by the sensor.

7. The aerosol generating device of claim 1, further comprising a sensor configured to detect a physical change in an airflow path,
wherein the controller generates the second control signal in response to a second sensing signal output by the sensor.

8. The aerosol generating device of claim 1, further comprising an output unit configured to output information on a state of the aerosol generating device,
wherein the controller is further configured to operate the aerosol generating device in a first mode based on the first control signal, operate the aerosol generating device in a second mode based on the second control signal, and control the output unit such that the output unit outputs the information on the state of the aerosol generating device.

9. The aerosol generating device of claim 8, wherein the output unit is further configured to transfer the information on the state of the aerosol generating device to a user through at least one of vision, hearing, or tactile sense.

10. The aerosol generating device of claim 8, wherein the at least one heater includes:
a first heater configured to heat a stick inserted into a first portion of the aerosol generating device; and
a second heater configured to heat a liquid composition stored in a cartridge attached to or detached from a second portion of the aerosol generating device.

11. The aerosol generating device of claim 10, wherein the controller is further configured to control power supplied to the first heater such that a level of the power supplied to the first heater gradually decreases over time in the second mode.

12. The aerosol generating device of claim 10, wherein the controller is further configured to control power supplied to the second heater such that a level of the power supplied to the second heater in the second mode is lower than a level of the power supplied to the second heater in the first mode.

13. The aerosol generating device of claim 12, wherein the level of the power supplied to the second heater in the second mode corresponds to a lowest temperature of the second heater for generating an aerosol through the liquid composition.

14. An aerosol generating device comprising:
at least one heater configured to heat an aerosol generating material;
a memory storing at least one temperature profile and an operation time of the aerosol generating device;
a timer configured to count an operation time of the aerosol generating device; and
a controller configured to control power supplied to the at least one heater,
wherein the controller is further configured to generate a second control signal for pausing the timer and a first control signal for restarting the timer, and disconnect the power supplied to the at least one heater when the operation time expires.

15. The aerosol generating device of claim 14, further comprising an input unit configured to receive information input by a user, and a sensor configured to detect a physical change in an airflow path,
wherein the controller is further configured to generate the first control signal in response to a first sensing signal output by the sensor or generate the first control signal in response to a first input of the user, and generate the second control signal in response to a second sensing signal output by the sensor or generate the second control signal in response to a second input of the user, and
a polarity of the first sensing signal is opposite to a polarity of the second sensing signal.
